(19) United States
(12) Patent Application Publication
(10) Pub. No.: US 2016/0380491 A1
(43) Pub. Date: Dec. 29, 2016

(54) SALIENT POLE ROTOR

(71) Applicant: SIEMENS AKTIENGESELLSCHAFT, 80333 München (DE)

(72) Inventor: ERIK KROMPASKY, HAVORCOVICE (CZ)

(73) Assignee: SIEMENS AKTIENGESELLSCHAFT, 80333 München (DE)

(21) Appl. No.: 15/038,949

(22) PCT Filed: Nov. 13, 2014
(86) PCT No.: PCT/EP2014/074518

§ 371 Date: May 24, 2016

(30) Foreign Application Priority Data
Nov. 25, 2013 (EP) 13194270.8

(51) Int. Cl. H02K 1/24; H02K 1/30; H02K 1/32; H02K 3/18

(52) U.S. Cl. CPC H02K 1/24; H02K 3/18; H02K 1/30; H02K 1/32

(57) ABSTRACT

A salient pole rotor includes at least two radially outward facing pole bodies, electrical windings respectively disposed in surrounding relationship to the pole bodies, and pole shoes provided on the pole bodies. Each pole shoe is arranged radially outwardly on the electrical winding of the pole body and has a width which is wider in a circumferential direction than a width of the pole body. The pole shoe has a radially inward facing, tapering projection of a shape complementing a radially inwardly tapering groove on a radial external surface of the pole shaft. The pole shoe and the pole body are connected in a mechanically releasable manner.

The invention relates to a salient pole rotor having at least two radially outward facing pole bodies, an electrical winding surrounding the respective pole body in each case, and a pole shoe in each case, the respective pole shoe being arranged radially outwardly on the respective pole body. The invention furthermore relates to an electric machine having a salient pole rotor of said type.

An electric machine of said type is known for example from the German utility model patent DE 90 03 390 U1.

The object underlying the invention is to provide a salient pole rotor which is easier to produce and to maintain.

This object is achieved by means of a salient pole rotor of the type cited in the introduction in that the respective pole shoe is wider in the circumferential direction than the respective pole body and is arranged radially outwardly on the respective winding, the respective pole shoe having a radially inward facing, tapering projection, the respective pole body having on its radial external surface a radially inwardly tapering groove complementary to the respective projection, the respective pole shoe and the respective pole body being connected in a mechanically releasable manner.

This object is furthermore achieved by means of an electric machine of the type cited in the introduction in that the electric machine has a salient pole rotor according to the invention.

The mechanically releasable connection of the respective pole shoe to the respective pole body enables the respective pole body to be provided initially with the respective winding. The respective winding can, for example, be wound in advance and if necessary impregnated or immersed or produced from flat copper rods which are soldered together. For a particularly simple mounting of the winding, the respective pole body preferably has a constant width from radially inward to radially outward in the circumferential direction. All in all, therefore, comparatively simple winding machines can be employed for winding the respective pole body, thereby considerably simplifying the production of the salient pole rotor. At the same time there are in principle less severe constraints in respect of weight or diameter, which means that the windings or poles embodied in said manner can be manufactured or wound comparatively easily.

In particular after the respective pole body has been provided with the associated winding, the respective pole shoe is mounted onto the pole body and connected to the latter in a mechanically releasable manner. Because the respective pole shoe is wider in the circumferential direction than the associated pole body, the respective pole shoe is able to absorb centrifugal forces of the respective winding occurring during operation and pass on said forces by way of the mechanically releasable connection. Preferably the respective pole shoe is at least as wide in the circumferential direction as the respective winding.

Should maintenance or repair, in particular of the winding, be necessary, the mechanically releasable connection can be separated again and the respective pole shoe removed in order to repair or replace the winding. The winding can subsequently be reinstalled and the respective pole shoe once again connected to the respective pole body in a mechanically releasable manner, thereby greatly simplifying the maintenance of the salient pole rotor.

In this case the respective tapering projection and the respective groove complementary thereto prevent unwanted movements of the pole shoe in relation to the pole body. This enables in particular the respective pole shoe to be reliably fixed and positioned on the respective pole body, thereby making the assembly and installation of the respective pole shoe both more reliable and easier.

In an advantageous embodiment of the invention, at least one short-circuit rod is arranged in the respective pole shoe. In said arrangement the at least one short-circuit rod is implemented as part of a squirrel cage, for which purpose the short-circuit rods are connected to one another at the axial end in each case by way of short-circuit rings and shorted. The squirrel cage enables an asynchronous startup of the electric machine. The respective short-circuit rod is in this case advantageously arranged in a groove extending substantially in the axial direction in the respective pole shoe, the groove being arranged on the radial outside face of the respective pole shoe and being implemented for example as open or closed.

In another advantageous embodiment of the invention the respective pole shoe is implemented in laminated form, an electrically insulating layer being arranged in each case between the laminations of the respective pole shoe.

The respective pole shoe is implemented in laminated form, the laminations being stacked in the axial direction. In such an arrangement the respective pole shoe is a section of the salient pole rotor in which a particularly high magnetic flux density or induction occurs during operation, such that the pole shoe plays an important role in respect of the losses or, as the case may be, the efficiency of the electric machine. The lamination of the respective pole shoe permits the losses of the salient pole rotor to be reduced and enables a smaller air gap to be provided with respect to a stator surrounding the rotor. In addition this enables the amount of copper required for the exciter winding to be reduced, which ultimately can also be used to realize larger and more powerful electric machines.

Because the laminations of the respective pole shoe are insulated from one another by a respective electrically insulating layer, eddy currents induced during operation are avoided or reduced, this having an advantageous effect on the magnetic properties of the salient pole rotor and on the efficiency of the electric machine.

In a further advantageous embodiment of the invention, the salient pole rotor has a wheel flange comprising at least two wheel flange segments, the respective wheel flange segment having at least one of the radially outward facing pole bodies.

In this case the wheel flange can be compared with a hollow cylinder which is composed of at least two wheel flange segments which are offset relative to one another in the circumferential direction. Because the respective wheel flange segment has at least one of the pole bodies, a construction having exceptional mechanical load-bearing capacity is achieved, since mechanical forces impinging on the respective pole body act directly on the wheel flange and finally can be passed on to a hub or shaft of the salient pole rotor. In particular it is additionally ensured in this way that essentially no forces are transferred from the respective pole body to the respective pole shoe.

In addition, the wheel flange segments can be mass-produced, thereby enabling the manufacturing costs to be reduced. Overall, the construction in this case permits the different manufacturing steps, such as the production of the pole shoes or the wheel flange segments with the pole bodies or the winding of the pole bodies, to be carried out separately from one another.

In a further advantageous embodiment of the invention, the salient pole rotor in this case has a wheel spider in relation to which the wheel flange is coaxially arranged and to which the wheel flange is connected.

The wheel flange is lightweight and nonetheless has a high mechanical load-bearing capacity, in particular in comparison with a solid hub or rim design. The wheel flange or wheel flange segments are in this case connected to the wheel spider for example by means of shrink-fitting or welding-on of the wheel flange, in which case a mechanically releasable connection to the wheel spider can also be used. In particular for the embodiment variant of the salient pole rotor in which the respective pole shoe has the blind hole and the respective pole body has the boreholes passing radially through it, radial breakthroughs can be provided in the wheel spider. This permits the respective bolt to be guided through the respective pole body and the wheel spider. In this way a mechanically releasable connection of the respective pole shoe to the respective pole body or the respective wheel flange segment and finally to the wheel spider can be created. For example, the respective bolt can in turn have an external thread at its radially inner end such that the bolt is tensioned for example by means of a nut. Alternatively, instead of a nut, a bar extending in the axial direction can in turn be provided which in turn has an internal thread for each bolt. It is also conceivable for the bolt to serve solely for the mechanically releasable connection of the respective pole shoe to the wheel flange and the wheel flange to be connected to the wheel spider by way of separate bolts or fastening means.

In a further advantageous embodiment of the invention the wheel spider in this case has at least two wheel spider segments which are welded to one another.

Because the wheel spider is composed of at least two wheel spider segments, greater wheel spider diameters can also be realized. In particular for large diameters, the production costs can in this case be reduced, since the individual wheel spider segments can be manufactured easily and in large quantities. In particular this permits the wheel spider segments to be produced at a different location from the location at which the wheel spiders and possibly further parts of the salient pole rotor are produced.

In a further advantageous embodiment of the invention, the salient pole rotor has a shaft and a shaft projection facing radially outward from the shaft, wherein the wheel flange is arranged coaxially with the shaft and is connected to the shaft projections.

In a further advantageous embodiment of the invention, the respective wheel flange segment in this case has stacked, mutually touching plates, the laminations of the respective pole shoe being thinner than the plates of the respective wheel flange segment.

Such an implementation of the respective wheel flange segment enables the production costs to be lowered, since comparatively low-cost materials can be used for the respective wheel flange segment. Accordingly, only those sections of the salient pole rotor which have a particularly high magnetic flux density or induction during operation are implemented with more expensive materials having particularly advantageous magnetic properties. Sections of said type are in particular the respective pole shoes which are stacked and in particular are implemented with the electrically insulating layer between the laminations. In contrast, the plates of the respective wheel flange segments are comparatively thick in dimension, the plates being in contact with one another and consequently not being electrically insulated from one another. Owing to their mechanical robustness, plates of said type can be assembled particularly easily into the respective wheel flange segment.

In particular the respective wheel flange segment can in this case have at least one axial through-hole in which a clamping bolt is arranged in each case for bracing the stacked plates. A particularly stable salient pole rotor construction is achieved as a result of bracing the plates.

In a further advantageous embodiment of the invention, the respective pole shoe in this case has a radially inwardly open blind hole in which an internal thread is arranged, the respective pole body having a borehole passing through the respective wheel flange segment in the radial direction, a bolt having an external thread being provided in each case and being passed through the respective borehole and screwed into the internal thread of the respective blind hole.

The respective pole shoe can be fastened by means of the respective bolt to the respective pole body in a mechanically releasable manner, the respective bolt merely passing on forces of the respective pole shoe and the respective winding to the respective pole body. Comparatively little stress is placed on the respective bolt as a result. In particular this avoids the respective bolt additionally having to absorb forces of the respective pole body, such as centrifugal forces occurring during operation, for example. Accordingly, a mechanically releasable connection of the pole shoe to the pole body is ensured which at the same time has a considerable mechanical load-bearing capacity.

To produce the mechanically releasable connection, the respective bolt has an external thread which can be screwed into the internal thread of the respective pole shoe. For that purpose the respective pole shoe can have for example a nut contained in a respective cavity of the pole shoe. Alternatively, provision can be made in the respective pole shoe for a closed, axially extending groove in which a bar is arranged. In order to fasten a respective bolt to the pole shoe, the bar has, for each bolt, a correspondingly arranged internal thread in a borehole or aperture of the bar. In particular when a plurality of bolts are connected in a mechanically releasable manner to the bar in the axial direction along the bar and as a result forces of the respective pole shoe and the respective winding can be transmitted by way of the bolts to the respective pole body, a mechanically releasable connection having a particularly high load-bearing capacity can be achieved. The bar has for example a round, rectangular or square cross-section.

By means of this construction it is ensured to a particular degree that forces acting solely on the respective pole shoe and the respective winding are transmitted by way of the respective bolt, as a result of which the salient pole rotor has a very high mechanical load-bearing capacity.

In an alternative advantageous embodiment of the invention the respective pole shoe has a borehole passing through in the radial direction, the respective pole body having a radially outwardly open blind hole in which an internal thread is arranged, there being provided in each case a bolt having an external thread which is passed through the respective borehole and is screwed into the internal thread of the respective blind hole.

By means of the respective bolt it is therefore possible to fasten the respective pole shoe to the respective pole body in a mechanically releasable manner. In this case the respective bolt merely passes on forces of the respective pole shoe and the respective winding to the respective pole body, with the result that the respective bolt is subjected to comparatively little stress, in particular compared to designs in which it is necessary to transmit the forces of the pole shoe, the winding and in addition the pole body. Thus, a mechanically releasable connection of the pole shoe to the pole body is ensured which simultaneously has a considerable mechanical load-bearing capacity.

To produce the mechanically releasable connection, the respective bolt has an external thread which can be screwed into the internal thread of the respective pole body. For that purpose the respective pole body can have for example a nut contained in a respective cavity of the pole body. Alternatively, there can be provided in the respective pole body a closed, axially extending groove in which a bar is arranged. In order to fasten a respective bolt to the pole body, the bar has, for each bolt, a correspondingly arranged internal thread in a borehole or aperture of the bar. in particular when a plurality of bolts are connected to the bar in the axial direction along the bar in a mechanically releasable manner and as a result forces of the respective pole shoe and the respective winding can be transmitted by way of the bolts to the respective pole body, a mechanically releasable connection having a particularly high load-bearing capacity can be achieved. The respective bar accordingly lends the laminated construction of the respective pole shoe a particular stability and rigidity over its entire axial length; the bar can have for example a round, rectangular or square cross-section. In particular, the respective bar can overlap the respective winding at its two axial ends, with the result that the respective winding is arranged radially further inward than the respective axial end of the bar. This enables a particularly good fixing of the winding to be achieved in the radial direction.

In a further advantageous embodiment of the invention, the respective pole shoe and/or the respective pole body have/has at least one cooling channel extending in the axial direction.

A cooling medium, for example air, oil or water, can be conducted through the respective cooling channel. This permits selective cooling of the salient pole rotor at those locations at which most lost heat is generated during operation and has to be dissipated. For example, the respective cooling channel can be embodied as a closed groove or borehole which is arranged in the respective pole shoe or in the respective pole body.

In another advantageous embodiment of the invention, the respective pole shoe and/or the respective pole body in this case have/has, at an interface to the electrical winding, an open groove in which the at least one cooling channel extending in the axial direction is arranged.

Since the respective electrical winding can become exceptionally hot during operation, the arrangement of the respective cooling channel in the immediate neighborhood of the respective electrical winding allows particularly efficient cooling. A cooling channel of said type can be formed for example by a tube or a hollow profile which is arranged in the open groove in the respective pole shoe or, as the case may be, in the respective pole body and at the same time touches the respective electrical winding.

In a further advantageous embodiment of the invention, the salient pole rotor has at least one cooling channel extending in the radial direction, wherein the at least one cooling channel extending in the radial direction extends in a respective groove through the respective pole body and/or through the respective pole shoe and/or wherein the at least one cooling channel extending in the radial direction extends at least partially between the respective pole body and the winding.

By means of the respective cooling channel extending in the radial direction, the cooling of the salient pole rotor can be improved. To this end provision is made for a respective groove in the respective pole body and/or in the respective pole shoe, wherein the respective groove is for example embodied so as to be closed and, coming from the respective pole body in the radial direction, is continued into the respective pole shoe. Alternatively, or in addition, the respective cooling channel extending in the radial direction can be arranged at least partially between the respective pole body and the winding. This cooling channel can in particular be supplied with cooling air by means of a groove extending in the radial direction through the respective pole body.

In a further advantageous embodiment of the invention, the electric machine can be operated at a capacity of at least 1 MW, in particular more than 10 MW, and/or the salient pole rotor has a diameter of at least 1 m, in particular more than 5 m.

In particular the invention also comprises an arrangement for a salient pole rotor, wherein the arrangement includes at least one respective wheel flange segment having at least one radially outward facing pole body and an associated pole shoe.

The different embodiments of the salient pole rotor explained hereintofore are particularly effective in larger and more powerful electric machines having an electrical capacity in the megawatt range and the salient pole rotor of which preferably has a diameter of at least 1 m or more than 5 m.

The invention is described and explained in more detail below with reference to the exemplary embodiments illustrated in the figures, in which:

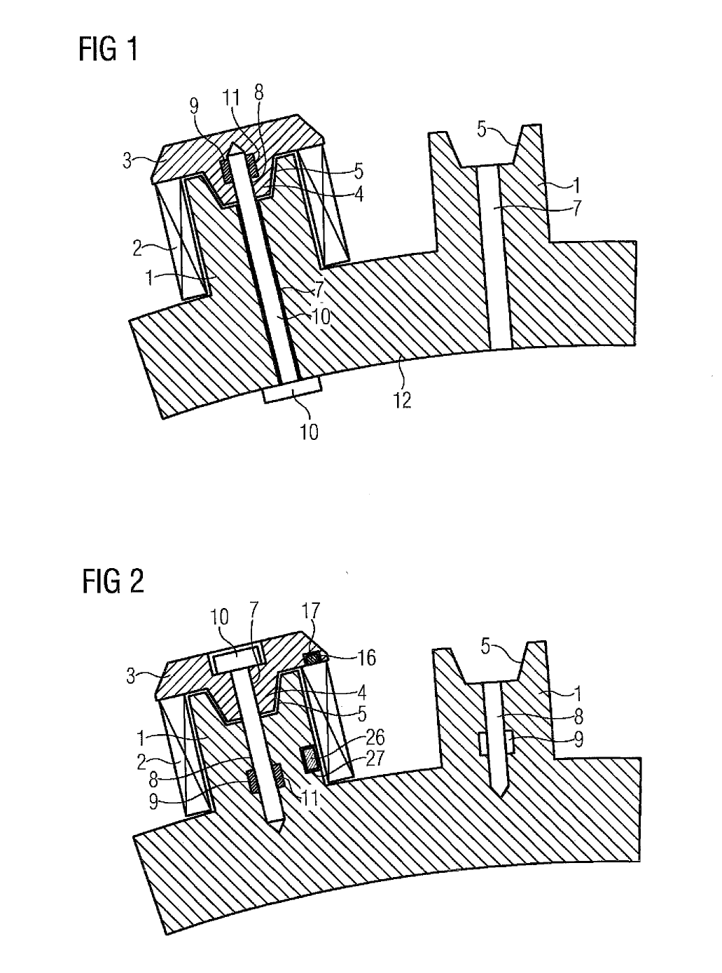

FIG. 1 shows a cross-section of a wheel flange segment of a first exemplary embodiment of the salient pole rotor according to the invention,

FIG. 2 shows a cross-section of a wheel flange segment of a second exemplary embodiment of the salient pole rotor according to the invention,

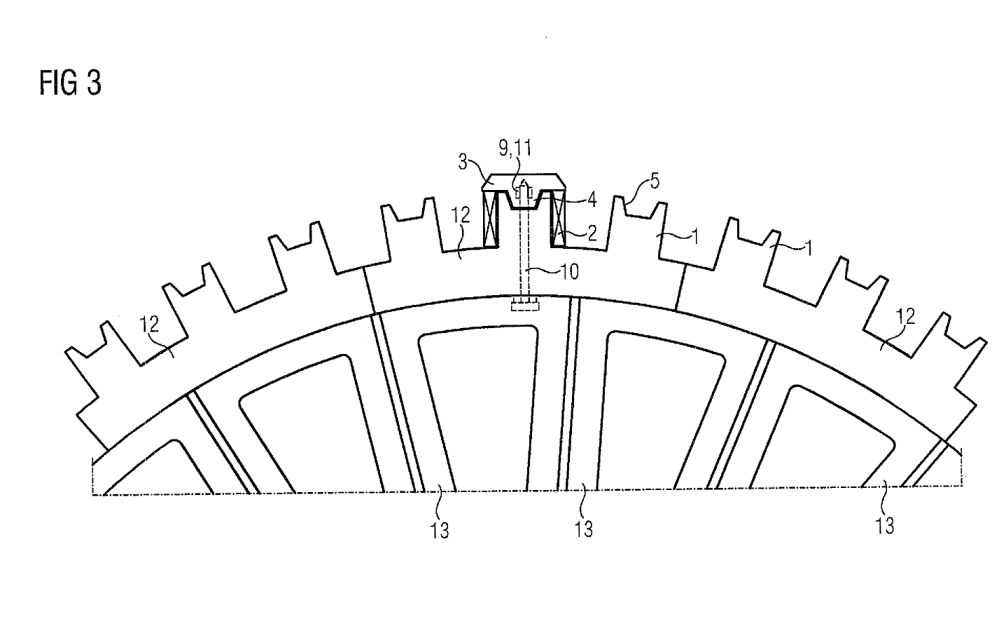

FIG. 3 shows a cross-section of a third exemplary embodiment of the salient pole rotor according to the invention,

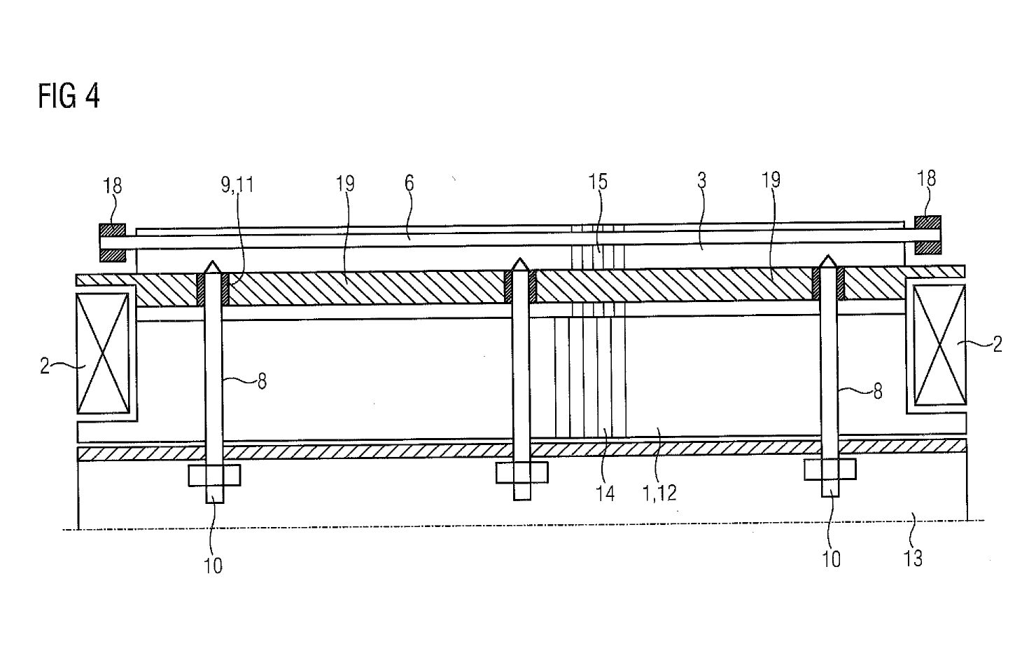

FIG. 4 shows a longitudinal section of a fourth exemplary embodiment of the salient pole rotor according to the invention,

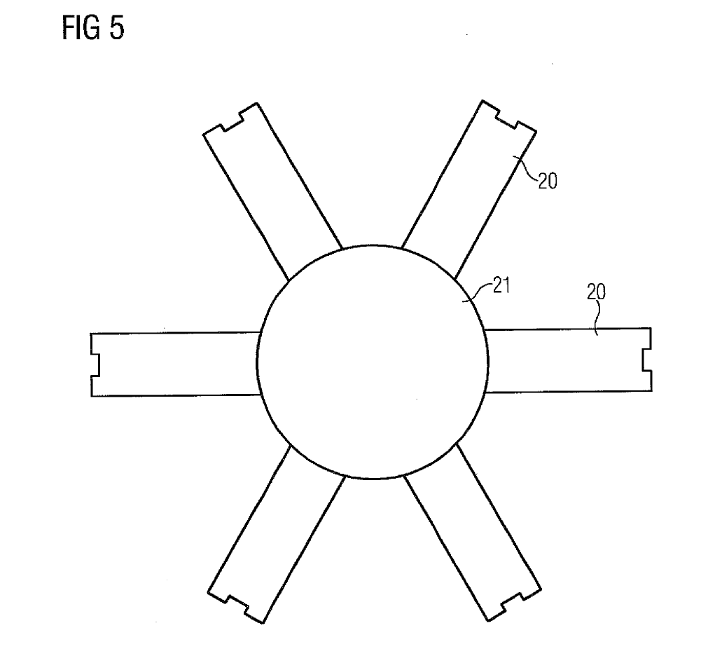

FIG. 5 shows an extract of a fifth exemplary embodiment,

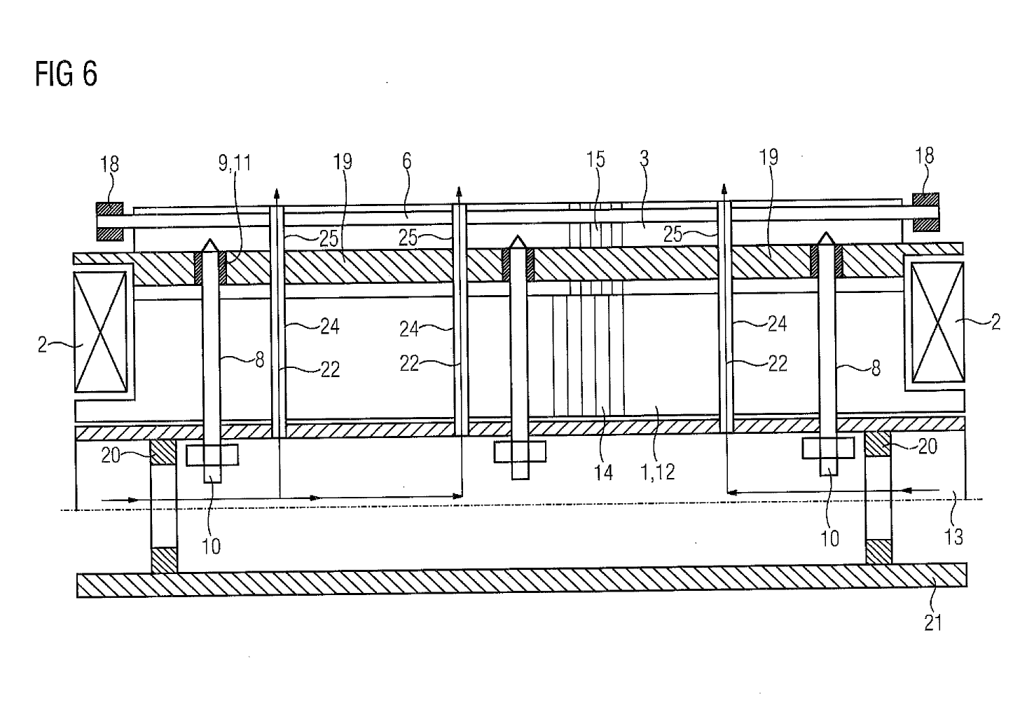

FIG. 6 shows a longitudinal section of a sixth exemplary embodiment, and

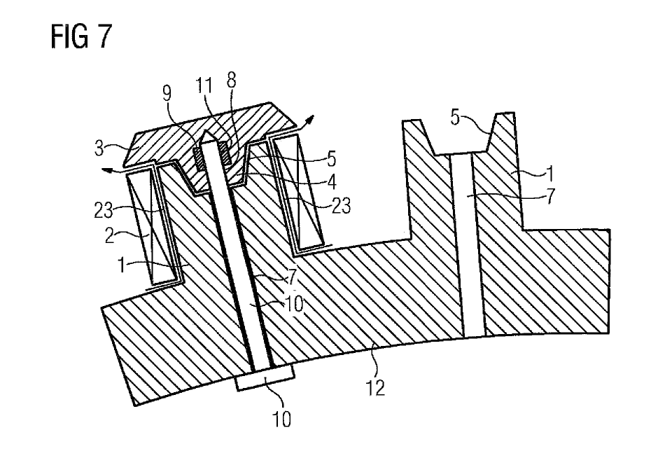

FIG. 7 shows a cross-section of a wheel flange segment of a seventh exemplary embodiment.

FIG. 1 shows a cross-section of a wheel flange segment 12 of a first exemplary embodiment of the salient pole rotor according to the invention.

The wheel flange segment 12 has two radially outward facing pole bodies 1, each of which has a borehole 7 passing through the respective wheel flange segment 12 in the radial direction. In addition, the respective pole body 1 has on its radial external surface a radially inwardly tapering groove 5. For improved clarity of illustration, the below-described details are shown only for the pole body 1 depicted on the left in the drawing of FIG. 1.

The respective pole body 1 is surrounded by an electrical winding 2 which for assembly and installation purposes can be initially wound and if necessary impregnated to provide insulation, and only then mounted onto the respective pole body 1. Adjoining the respective pole body 1 and the respective winding 2 radially outwardly is a pole shoe 3 which on its radial internal side has a radially inwardly tapering projection 4. In this arrangement the projection 4 is embodied in such a way that it fits comfortably into the respective groove 5 and when a pole shoe 3 is mounted ensures a good fixing and positioning of the respective pole shoe 3. The respective pole shoe 3 is in this case wider in the circumferential direction than the respective pole body 1 and has a radially inwardly open blind hole 8 having an internal thread 9.

To realize a mechanically releasable connection of the respective pole shoe 3 to the respective pole body 1 or, as the case may be, the respective wheel flange segment 12, a bolt 10 having an external thread 11 is provided which is guided through the respective borehole 7 and screwed into the internal thread 9 of the respective blind hole 8. The bolt 10 can in this case, as shown in FIG. 1, have a head by means of which radial forces can be transmitted to the respective wheel flange segment 12. Alternatively, instead of a head, a nut for example can be used which is screwed onto a further external thread of the bolt 10 in order to transmit radial forces to the respective wheel flange segment 12.

FIG. 2 shows a cross-section of a wheel flange segment of a second exemplary embodiment of the salient pole rotor according to the invention.

The wheel flange segment 12 has two radially outward facing pole bodies 1, each of which has a radially outwardly open blind hole 8 having an internal thread 9. In addition, the respective pole body 1 has on its radial external surface a radially inwardly tapering groove 5. For improved clarity of illustration, the below-described details are shown only for the pole body 1 depicted on the left in the drawing of FIG. 2.

The respective pole body 1 is surrounded by an electrical winding 2 which for assembly and installation purposes can be initially wound and if necessary impregnated to provide insulation, and only then mounted onto the respective pole body 1. Adjoining the respective pole body 1 and the respective winding 2 radially outwardly is a pole shoe 3 which on its radial internal side has a radially inwardly tapering projection 4. In this arrangement the projection 4 is embodied in such a way that it fits comfortably into the respective groove 5 and when a pole shoe 3 is mounted ensures a good fixing and positioning of the respective pole shoe 3. The respective pole shoe 3 is in this case wider in the circumferential direction than the respective pole body 1 and has a borehole 7 passing through the respective pole shoe 3 in the radial direction.

To realize a mechanically releasable connection of the respective pole shoe 3 to the respective, pole body 1 or, as the case may be, the respective wheel flange segment 12, a bolt 10 having an external thread 11 is provided which is guided through the respective borehole 7 and screwed into the internal thread 9 of the respective blind hole 8. The bolt 10 can in this case, as shown in FIG. 2, have a head which can absorb radial forces of the respective pole shoe 3. Alternatively, instead of a head, a nut for example can be used which is screwed onto a further external thread of the bolt 10 in order to absorb radial forces of the respective pole shoe 3.

In order to achieve improved cooling, the respective pole shoe 3 has an open groove 17 which is arranged at an interface of the respective pole shoe 3 to the electrical winding 2 and in which is located a cooling channel 16 extending in the axial direction. The cooling effect is additionally enhanced by means of an open groove 27 which is arranged at an interface of the respective pole body 1 to the electrical winding 2 and in which is located a cooling channel 26 extending in the axial direction. In principle it is also possible in this arrangement to dispense with one or both of the grooves, in which case the salient pole rotor according to the first exemplary embodiment can also be provided with grooves and cooling channels of said kind.

FIG. 3 shows a cross-section of a third exemplary embodiment of the salient pole rotor according to the invention. In this case the third exemplary embodiment has a similarity to the first exemplary embodiment, the same reference numerals as in FIG. 1 identifying the same objects.

In contrast to the first exemplary embodiment, each of the wheel flange segments 12 now has three pole bodies 1. The wheel flange segments 12 form a wheel flange which is arranged coaxially with a wheel spider, the wheel spider having a plurality of wheel spider segments 13 which are welded to one another. The wheel flange can be joined to the wheel spider for example by shrink-fitting or welding. A mechanically releasable connection is also conceivable, for example by means of the respective bolt 10 or further bolts or connecting means.

FIG. 4 shows a longitudinal section of a fourth exemplary embodiment of the salient pole rotor according to the invention. In this case the fourth exemplary embodiment has a similarity with the first and third exemplary embodiment, the same reference numerals as in FIGS. 1 and 3 again designating the same objects.

The salient pole rotor according to the fourth exemplary embodiment has short-circuit rods 6 which are arranged in the respective pole shoes 3 and which, at their axial ends, are in each case connected to one another by means of a respective short-circuit ring 18. The respective pole shoes 3 are implemented in laminated form.

Also provided are a plurality of bolts 7 which are passed through respective boreholes 7 through the respective wheel flange segment 12 and engage in a respective internal thread 9 arranged in the respective pole shoe 3. In this arrangement a bar 19 is provided which is arranged in the respective pole shoe 3 and which has a respective aperture having a respective internal thread 9 at the axial position of the respective bolt 7. Within the scope of the exemplary embodiment the bar 19 extends beyond the respective winding 2 at its two axial ends, such that the respective winding 2 is arranged radially further inward than the respective axial end of the bar 19. This enables a particularly good fixing of the winding 2 in the radial direction.

In the axial direction the respective laminated pole shoe 3 has stacked laminations 15 and the respective wheel flange segment 12 has axially stacked, mutually touching plates 14. In this arrangement the laminations 15 are electrically separated from one another by an insulating layer, the laminations 15 being implemented thinner than the plates 14.

FIG. 5 shows an extract of a fifth exemplary embodiment. In this case, only a shaft 21 and shaft projections 20 facing radially outward from the shaft 21 are shown. The rest of the salient pole rotor can, for example, be embodied as in one of the other exemplary embodiments with the exception of the third exemplary embodiment.

FIG. 6 shows a longitudinal section of a sixth exemplary embodiment, which is very similar to the fourth exemplary embodiment, with the result that in the following only the differences will be described. The salient pole rotor has a shaft 21 and shaft projections 20 mounted radially outward on the shaft 21, which shaft projections 20 are finally connected to the wheel flange. The salient pole rotor has in this case a plurality of cooling channels 22 leading radially outward, which in each case are formed by a respective groove 24 in the pole body 1 and by a respective groove 25 in the pole shoe 3. In this case cooling air can initially be fed to the respective cooling channel 22 in the axial direction, for example along the shaft 21 and between shaft projections 20 adjacent in the circumferential direction. For the cooling channels 22 leading radially outward, however, a salient pole rotor with a wheel spider according to the third exemplary embodiment can be used.

FIG. 7 shows a cross-section of a wheel flange segment of a seventh exemplary embodiment. Between the winding 2 and the pole body 1 a cooling channel 23 is arranged, through which cooling air can flow through substantially in the radial direction. The cooling channel 23 is in this case continued between the winding 2 and the pole shoe 3, so that the cooling air flowing radially outward is guided out of the cooling channel 23 again.

The cooling channel 23 can in this case be provided in addition to the cooling channels of the other exemplary embodiments which have already been described above.

To sum up, the invention relates to a salient pole rotor having at least two radially outward facing pole bodies, an electrical winding surrounding the respective pole body in each case, and a pole shoe in each case, the respective pole shoe being arranged radially outwardly on the respective pole body. The invention furthermore relates to an electric machine having a salient pole rotor of said type. In order to provide a salient pole rotor which is easier to produce and to maintain, it is proposed that the respective pole shoe be wider in the circumferential direction than the respective pole body and arranged radially outwardly on the respective winding, the respective pole shoe having a radially inward facing, tapering projection, the respective pole body having on its radial external surface a radially inwardly tapering groove complementary to the respective projection, the respective pole shoe and the respective pole body being connected in a mechanically releasable manner.

1.-15. (canceled)

16. A salient pole rotor, comprising:
at least two radially outward facing pole bodies;
electrical windings respectively disposed in surrounding relationship to the pole bodies; and
pole shoes provided on the pole bodies, respectively, each said pole shoe being arranged radially outwardly on the electrical winding of the pole body and having a width which is wider in a circumferential direction than a width of the pole body, said pole shoe having a radially inward facing, tapering projection of a shape complementing a radially inwardly tapering groove on a radial external surface of the pole shaft, said pole shoe and said pole body being connected in a mechanically releasable manner.

17. The salient pole rotor of claim 16, further comprising at least one short-circuit rod arranged in the pole shoe.

18. The salient pole rotor of claim 16, wherein the pole shoe is formed by laminations, and further comprising electrically insulating layers respectively arranged between adjacent laminations of the pole shoe.

19. The salient pole rotor of claim 16, further comprising a wheel flange having at least two wheel flange segments, each said wheel flange segment having at least one of the radially outward facing pole bodies.

20. The salient pole rotor of claim 19, further comprising a wheel spider arranged in coaxial relationship to the wheel flange and connected to the wheel flange.

21. The salient pole rotor of claim 20, wherein the wheel spider has at least two wheel spider segments which are welded to one another.

22. The salient pole rotor of claim 19, further comprising a shaft and shaft projections facing radially outward from the shaft, said wheel flange being arranged in coaxial relationship to the shaft and connected to the shaft projections.

23. The salient pole rotor of claim 19, wherein the pole shoe is formed by laminations, said wheel flange segment including stacked, mutually touching plates, said laminations having a width which is thinner than a width of the plates of the wheel flange segment.

24. The salient pole rotor of claim 19, wherein the pole shoe has a radially inwardly open blind hole formed with an internal thread, said pole body having a borehole sized to extend through the wheel flange segment in a radial direction, and further comprising a bolt having an external thread, said bolt being passed through the borehole of the pole body and threadably engaged with the internal thread of the blind hole.

25. The salient pole rotor of claim 16, wherein the pole shoe has a borehole configured to extend through the pole shoe in a radial direction, said pole body having a radially outwardly open blind hole formed with an internal thread, and further comprising a bolt having an external thread, said bolt being passed through the borehole of the pole shoe and threadably engaged with the internal thread of the blind hole.

26. The salient pole rotor of claim 16, wherein at least one member selected from the group consisting of the pole shoe and the pole body has at least one axial cooling channel extending in an axial direction.

27. The salient pole rotor of claim 26, wherein the member has at an interface to the electrical winding an open groove in which the at least one cooling channel is arranged.

28. The salient pole rotor of claim 16, further comprising at least one cooling channel extending in a radial direction in at least one of two ways, a first way in which the cooling channel extends in a groove through at least one of the pole body and the pole shoe, a second way in which the cooling channel extends at least partially between the pole body and the electric winding.

29. An electric machine, comprising a salient pole rotor which includes at least two radially outward facing pole bodies, electrical windings respectively disposed in surrounding relationship to the pole bodies, and pole shoes provided on the pole bodies, respectively, each said pole shoe being arranged radially outwardly on the electrical winding of the pole body and having a width which is wider in a circumferential direction than a width of the pole body, said pole shoe having a radially inward facing, tapering projection of a shape complementing a radially inwardly tapering groove on a radial external surface of the pole shaft, said pole shoe and said pole body being connected in a mechanically releasable manner.

30. The electric machine of claim 29, constructed for operation at a capacity of at least 1 MW.

31. The electric machine of claim 29, constructed for operation at a capacity of more than 10 MW.

32. The electric machine of claim 29, wherein the salient pole rotor has a diameter of at least 1 m.

33. The electric machine of claim 29, wherein the salient pole rotor has a diameter of more than 5 m.
